(19) United States
(12) Patent Application Publication
(10) Pub. No.: US 2021/0210061 A1
(43) Pub. Date: Jul. 8, 2021

(54) SOUND ISOLATION STRUCTURE

(71) Applicant: Toyota Motor Engineering & Manufacturing North America, Inc., Plano, TX (US)

(72) Inventors: Xiaoshi Su, Ann Arbor, MI (US); Debasish Banerjee, Ann Arbor, MI (US)

(21) Appl. No.: 16/736,140

(22) Filed: Jan. 7, 2020

(51) Int. Cl. G10K 11/172

(52) U.S. Cl. CPC G10K 11/172

(57) ABSTRACT

A sound isolation structure includes an array of resonators. At least one of the resonators forming the array of resonators may include a housing having a cavity, an opening to the cavity, and a neck portion extending into the cavity from the opening of the housing. The cavity may be in the form of an air channel having an open end connected to the opening and a terminal end.

### TECHNICAL FIELD

The present disclosure relates to sound isolation structures.

### BACKGROUND

The background description provided is to generally present the context of the disclosure. Work of the inventors, to the extent it may be described in this background section, and aspects of the description that may not otherwise qualify as prior art at the time of filing, are neither expressly nor impliedly admitted as prior art against the present technology.

Low-frequency noise issues are a common issue in a variety of different environments. There are several different solutions for managing low-frequency noises, but many have drawbacks. For example, conventional porous sound absorbing materials are only efficient for high-frequency noise reduction due to its high impedance nature. The sound transmission through porous materials is high if the material microstructure has a large porosity.

In the automotive industry, low-frequency noise has been a long-standing issue for passenger comfort. However, sound isolation performance is limited by the so-called “mass-law.” The “mass-law” states that doubling the mass per unit area increases the sound transmission loss (“STL”) by six decibels. Similarly, doubling the frequency increases the STL by six decibels. This effect makes it difficult to isolate low-frequency sound using lightweight materials. In order to achieve high STL, one may either reflect or absorb the sound energy. However, achieving high absorption and high STL at the same time is also difficult, because high absorption usually requires impedance matching, which leads to high transmission.

### SUMMARY

This section generally summarizes the disclosure and is not a comprehensive disclosure of its full scope or all its features.

In one embodiment, a sound isolation structure includes an array of resonators. At least one of the resonators forming the array of resonators may include a housing having a cavity, an opening to the cavity, and a neck portion extending into the cavity from the opening of the housing. The cavity may be in the form of an air channel having an open end connected to the opening and a terminal end.

In another embodiment, a resonator for isolation of sound may include a housing having an opening, an air channel disposed within the housing, and a neck portion extending into the air channel from the opening. The air channel may include an open end connected to an opening and a terminal end terminating within the housing.

In yet another embodiment, a sound isolation structure includes an array of resonators. At least one of the resonators forming the array of resonators includes a housing having an opening, a spiral air channel disposed within the housing, and a neck portion extending into the spiral air channel from the opening. The spiral air channel may have an open end connected to an opening and a terminal end terminating within the housing. The open end may be located adjacent to a center of the spiral air channel, and the terminal end may be located adjacent to a perimeter of the spiral air channel.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 illustrates an example of an acoustic structure for isolating sounds at one or more frequencies;

FIG. 2 illustrates an example of a resonator of the acoustic structure of FIG. 1;

FIG. 3 illustrates a cross-sectional view of the resonator of FIG. 2;

FIGS. 4 and 5 illustrate cutaway views of a resonator having a cavity;

FIGS. 6 and 7 illustrate cutaway views of a resonator having a spiral air channel; and

FIGS. 8A and 8B illustrate STL results of a resonator having a cavity;

FIG. 9 illustrates STL results of a resonator having a cavity and an extended neck;

FIGS. 10A and 10B illustrate STL results of a resonator having a spiral air channel;

FIGS. 11A and 11B illustrate STL results of a resonator having a spiral air channel that is extended; and

FIGS. 12A and 12B illustrate STL results of an acoustic structure incorporating resonators having different resonant frequencies.

The figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

A sound isolation structure may include a plurality of resonators that form an array. Each of the resonators may be a Helmholtz type resonator having a housing. In one example, the housing defines a cavity and a neck that extends inwardly into the cavity and defines an air channel. By extending the neck inward into the cavity, the air channel defined by the neck can be longer and can achieve low-frequency absorption in a more compact structure. In another example, the cavity may be in the form of a spiral air channel that extends from the neck and is in fluid communication with the air channel defined by the inwardly extending neck.

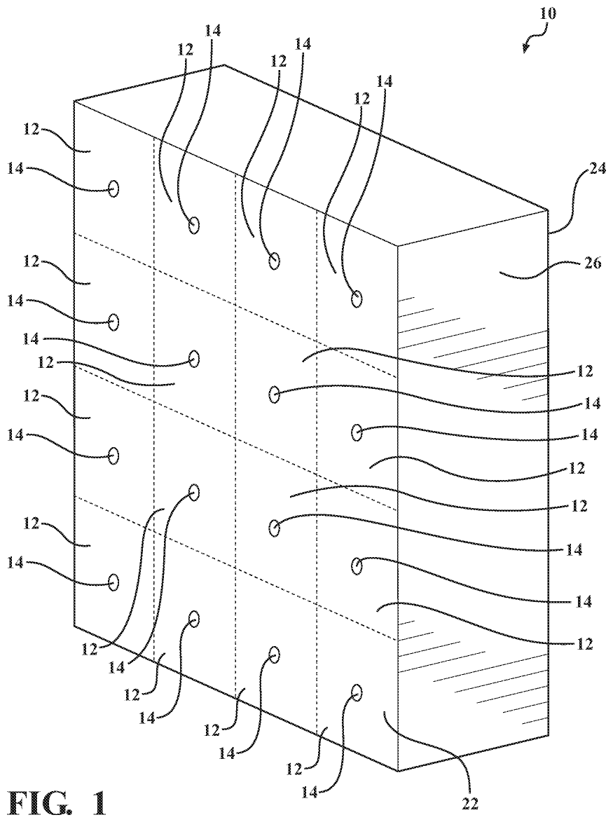

Referring to FIG. 1, an example of an acoustic structure 10 for isolating sounds at one or more frequencies is shown. The acoustic structure 10 is made up of a plurality of resonators 12, each having an opening 14. In this example, the plurality of resonators 12 form a two-dimensional array. The acoustic structure 10 includes sixteen resonators 12 that form a 4×4 array. It should be understood that the array forming the acoustic structure 10 can take any one of a number of different forms and can include any one of a number of resonators. Furthermore, it should be understood that the array does not need to be a two-dimensional array but can include any one of a number of different dimensions, such as a one-dimensional array and/or a three-dimensional array.

Additionally, it should also be understood that while the two-dimensional array shown in FIG. 1 has an equal number of rows and columns of resonators 12, any number of rows or columns of resonators 12 may be considered. For example, instead of being a 4×4 array as shown having sixteen resonators 12, the acoustic structure 10 could be a 5×4 array having twenty (20) resonators 12, a 3×7 array having twenty-one (21) resonators 12, a 13×25 array having three-hundred-twenty-five (325) resonators 12, or any other conceivable combinations or iterations thereof.

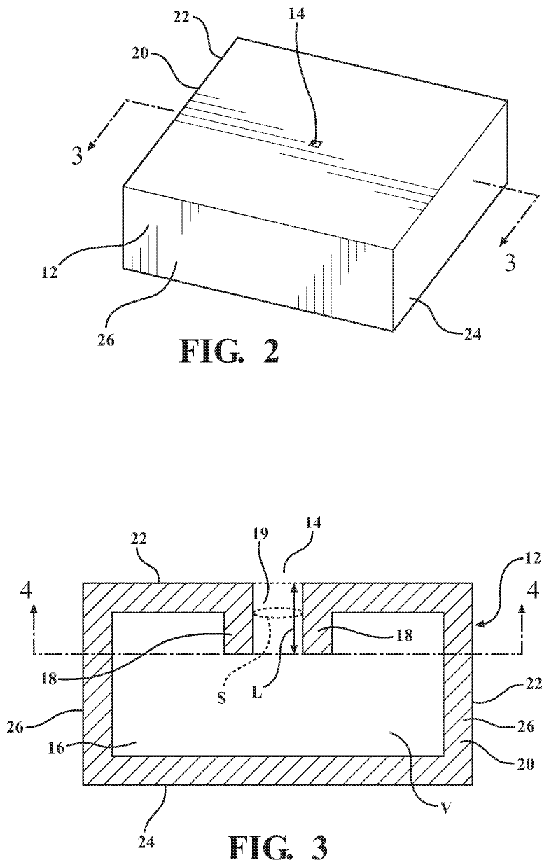

Referring to FIG. 2, a single resonator 12 from the acoustic structure 10 of FIG. 1 is shown. The resonator 12 includes a housing 20. The housing 20 may have portions defining a top portion 22, a bottom portion 24, and a perimeter portion 26 located between portions of the top portion 22 and the bottom portion 24. The top portion 22 of the housing 20 defines the opening 14 of the resonator 12.

The resonators 12 that form the acoustic structure 10 of FIG. 1 may be made of a plurality of resonators 12, similar to the resonator 12 of FIG. 2. In order to form the acoustic structure, the perimeter portion 26 of one resonator 12 may about the perimeter portion 26 of another resonator 12. By so doing, the acoustic structure 10 can be assembled using a plurality of individual resonators 12. However, it should be equally understood that instead of forming the acoustic structure 10 using a plurality of individual resonators 12, the acoustic structure 10 could be a single structure that has a housing that defines each resonator 12. Essentially, instead of building the acoustic structure 10 from a plurality of separate resonators 12, the acoustic structure 10 can be a purpose-built acoustic structure that has a predefined number of resonators.

Referring to FIG. 3, a cross-section of the resonator 12 of FIG. 2, generally taken along line 3-3, is shown. As stated previously, the resonator 12 includes a housing 20 having portions defining a top portion 22, a bottom portion 24, and a perimeter portion 26 located between portions of the top portion 22 and the bottom portion 24. In this example, the top portion 22, the bottom portion 24, and the perimeter portion 26 defined by the housing 20 are made of a single unitary piece. However, it should be understood that the housing 20 and/or portions of the housing 20 defining the top portion 22, the bottom portion 24, and the perimeter portion 26 may be formed of separate components that may be attached together through any one of a number of different attachment means, such as adhesives, press form fittings, screw-type fittings, bolts, nails, clamps, or any other methodology for joining one or more separate pieces together.

In this example, the housing 20 defines a cavity 16, having a volume V, located between and defined by the top portion 22, bottom portion 24, and perimeter portion 26 of the housing 20. The housing 20 also defines the opening 14 within the top portion 22. The opening 14 may be located in a substantially central location of the top portion 22. However, it should be understood that the opening 14 may be located anywhere along the top portion 22 of the housing 20 and does not necessarily need to be located within or near a central location.

The opening 14 is in fluid communication with the cavity 16 via a channel 19. The channel 19 is defined by inwardly extending neck portions 18 of the housing 20. As such, in this example, the neck portion 18, and therefore the channel 19, extend into the cavity 16 of the resonator 12. However, it should be understood that the neck portion 18, and therefore the channel 19, may also extend upward away from the top portion 22 in addition to extending inward into the cavity 16. The channel 19 has a length L and a cross-sectional surface area S.

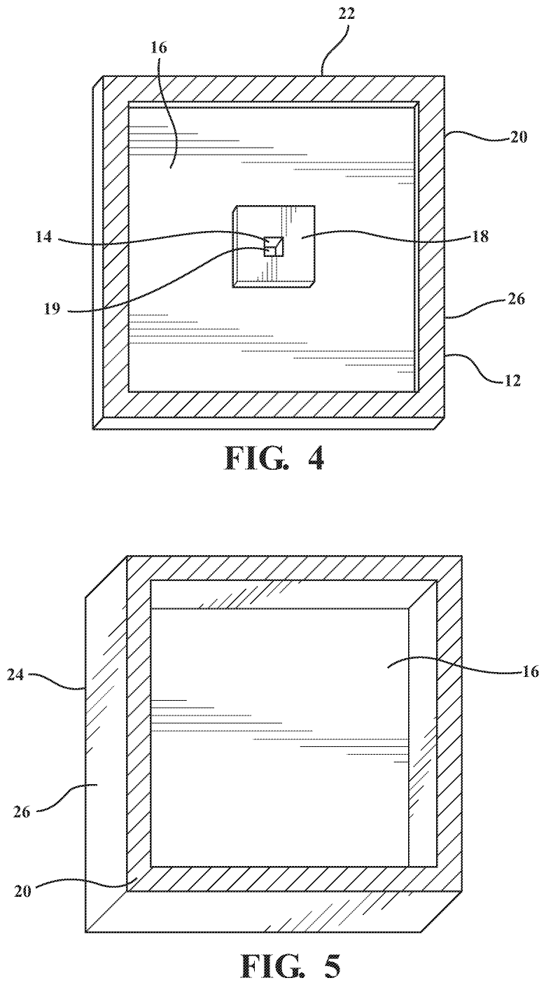

Referring to FIGS. 4 and 5, cutaway views of the resonator 12 generally are taken along lines 4-4 of FIG. 3 are shown. Moreover, FIG. 4 illustrates a view from the inside of the resonator 12 looking up (towards the opening 14) from line 4-4 of FIG. 3, while FIG. 5 illustrates a view of the inside of the resonator 12 looking down (away from the opening 14) from the line 4-4 of FIG. 3. In FIG. 4, the neck portion 18 of the housing 20 is shown to be substantially rectangular in shape. In addition, the opening 14 defined within the neck portion 18 of the housing 20 is also shown to be substantially rectangular in shape. It should be understood that the shape of the neck portion 18 and/or the opening 14 can be any one of a number of different shapes or combinations thereof.

FIGS. 4 and 5 both show portions of the cavity 16. Here, the cavity 16 is substantially rectangular in shape, but it should be understood that the shape of the cavity 16 can take any one of a number of different shapes.

Referring back to FIG. 3, with regards to the acoustic properties of the resonator 12, the resonant frequency (f_{H}) of the resonator 12 may be defined via the relationship

$${f}_{H} = \frac{c}{2 π} \sqrt{\frac{S}{VL}} ,$$

where c is the sound speed, S is the cross-sectional area of the channel 19, V is the volume of the cavity 16, and L is the effective length of the channel 19.

The effective properties of the material panel may change near the resonant frequency. The STL will be relatively high if the effective density is negative or much larger than the static density. The former condition results in an imaginary wavenumber inside the material so that the wave is exponentially decaying. The latter condition results in a very high acoustic impedance so that the transmission also drops significantly.

In order to achieve STL improvement at different frequencies, the length L of the channel 19 defined by the neck portions 18 is adjusted to change the frequency. The doubling the volume V of the cavity 16 may be equal to doubling the length L of the channel 19. The benefit of adjusting the length L of the channel 19 is that one does not have to sacrifice structural rigidity of the resonator 12 to reduce frequency.

As such, depending on the type of sound frequency one wishes to isolate, the volume V, length L of the channel 19, and/or the cross-sectional area S of the channel 19 may be adjusted to adjust the resonant frequency of the resonator 12. When an array resonators 12 are utilized to form an acoustic structure 10, such as the acoustic structure 10 of FIG. 1, the array of resonators 12 may each have the same resonant frequency or may have different resonant frequencies so as to expand the sound frequencies that the acoustic structure 10 can isolate.

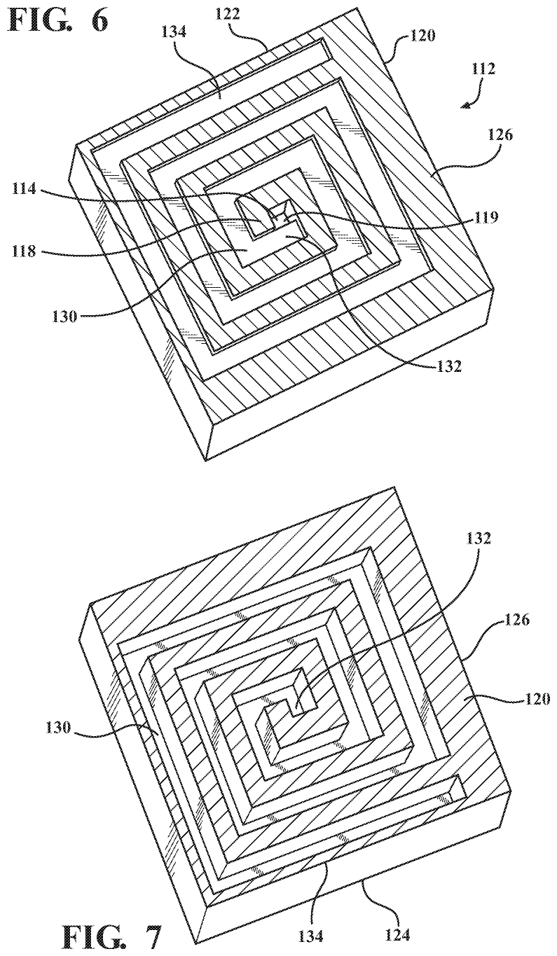

Referring to FIGS. 6 and 7, another example of the resonator 112 that may be utilized to form an acoustic structure, such as the acoustic structure 10 of FIG. 1 is shown Like reference numerals have been utilized refer to like elements, with the exception that the reference numerals have been incremented by 100. For example, the opening 114 of the resonator 112 corresponds to the opening 14 of the resonator 12. As such, unless otherwise mentioned, the description given previously regarding these elements is equally applicable here and will not necessarily be described again

Here, FIG. 6 illustrates a view from the inside of the resonator 112, similar to the view provided by FIG. 4 of the resonator 12. In like manner, FIG. 7 illustrates a view from the inside of the resonator 112, similar to the view provided by FIG. 5 of the resonator 12.

The resonator 112 differs from the resonator 12 in that the resonator 112 has essentially replaced the cavity 116 with a channel 130 that extends from the channel 119 defined by the neck portion 118 of the housing 120. In this example, the channel 130 is a spiral air channel that spirals from the channel 119 outwards towards the perimeter portion 126. In this example, the channel 130 is a rectangular spiral air channel. However, it should be understood that the channel 130 can take any one of a number of different shapes and does not necessarily need to be a rectangular channel, let alone a spiral channel.

The air channel 130 may include an open end 132 that is adjacent to the channel 119 and/or the opening 114. The open end 132 may be in fluid communication with the channel 119 and/or the opening 114. Opposite the open end 132 of the channel 130 may be a closed end 134. The closed end 134 may be located adjacent to the perimeter portion 126 of the housing 120. The closed end 134 is essentially a terminal end of the channel 130, wherein the channel 130 terminates

The design of the resonator 112 is based on the resonance of the long air channel 130, which occurs when the channel length of the long air channel 130 is a quarter of the wavelength. The STL improvement of the resonator 112 may be based on the negative or extremely high dynamic mass provided by the lengthy air channel 130.

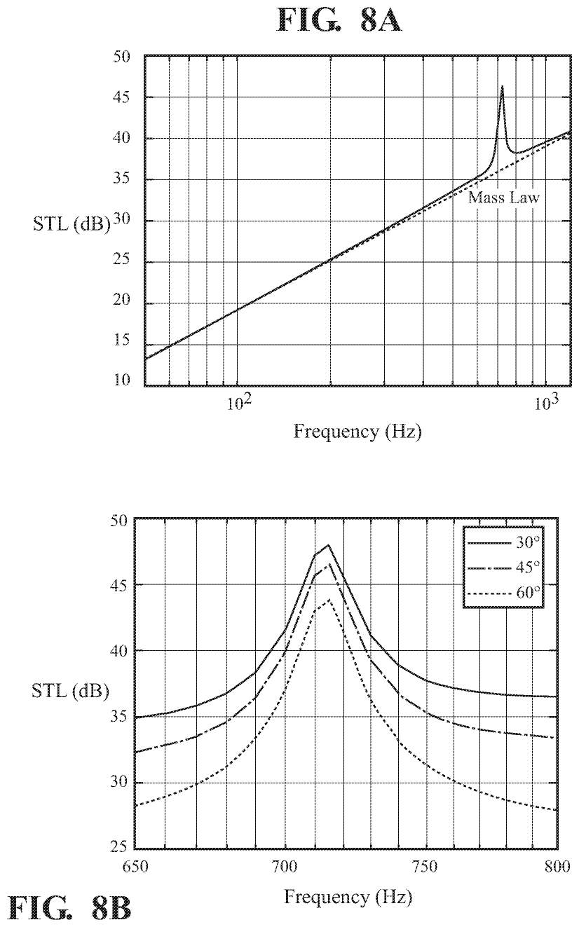

Referring to FIGS. 8A and 8B, the STL for the resonator 12 having a resonant frequency of 720 Hz is shown. In this example, the resonator 12 is made of silica glass having a 1 cm thickness and has a side length of 2.8 cm, a 6 cm thick cavity 16, and a 1.3 mm×1.3 mm opening 14. As shown in FIG. 8A, an improved STL is shown around 720 Hz. Furthermore, referring to FIG. 8B, this figure illustrates the STL at different angles of incidence. Here, it is worth noting the design of the resonator 12 is effective at fairly large incident angles such as 30°, 45°, and even 60°.

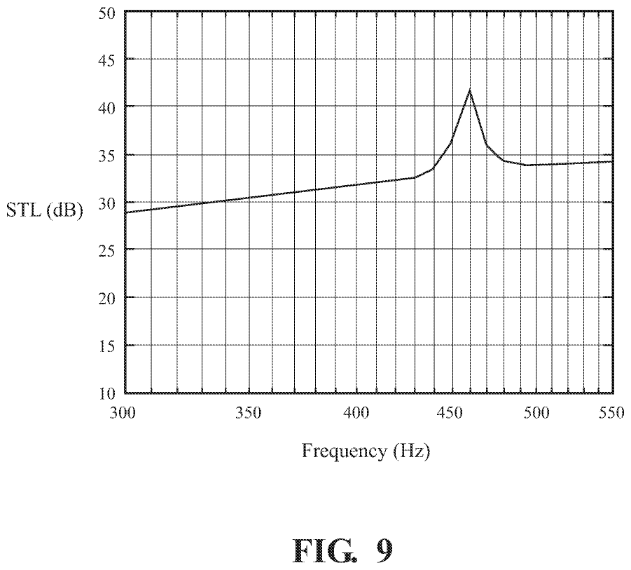

FIG. 9 illustrates that the resonant frequency of the resonator 12 can be reduced by extending the length of the channel 19. Here, the length L of the channel 19 is three times that of the resonator 12 used to generate the results shown in FIGS. 8A and 8B. Here, the STL peak appears at 460 Hz. Further reduction of the frequency is possible by extending the channel 19 inwardly into the cavity 16.

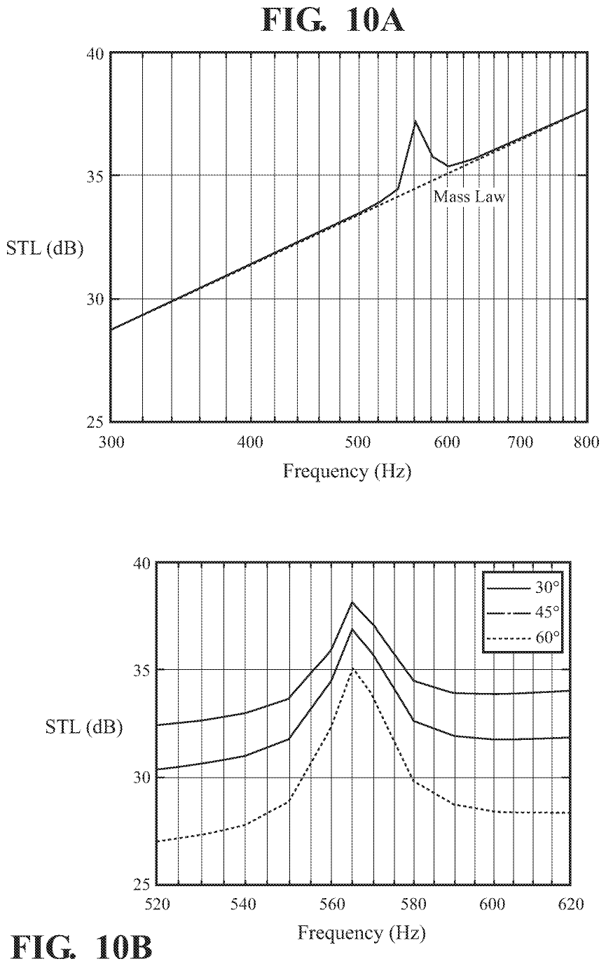

FIGS. 10A and 10B show the test results of a resonator 112 that utilizes a spiral channel 130. The thickness of the silica glass is 7 mm in this design. As such, the resonant frequency of this design is 560 Hz. FIG. 10A shows improved STL at the resonant frequency, while FIG. 10B shows broad-angle performance at fairly large incident angles such as 30°, 45°, and even 60°.

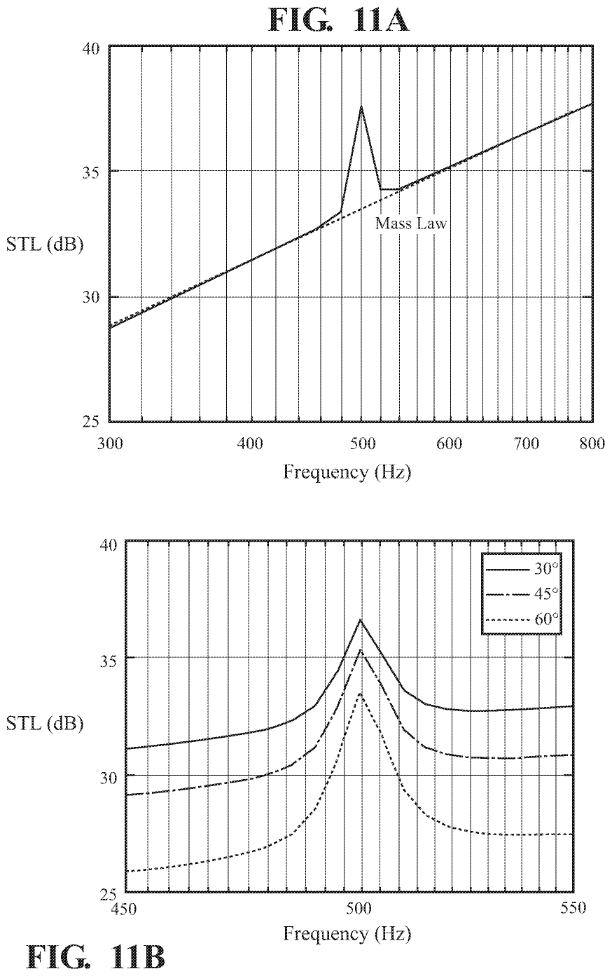

FIGS. 11A and 11B show the test results of a resonator 112 with a slightly longer channel 130. Here, the resonant frequency is 500 Hz. FIG. 11A shows improved STL at the resonant frequency, while FIG. 11B shows broad-angle performance at fairly large incident angles such as 30°, 45°, and even 60°.

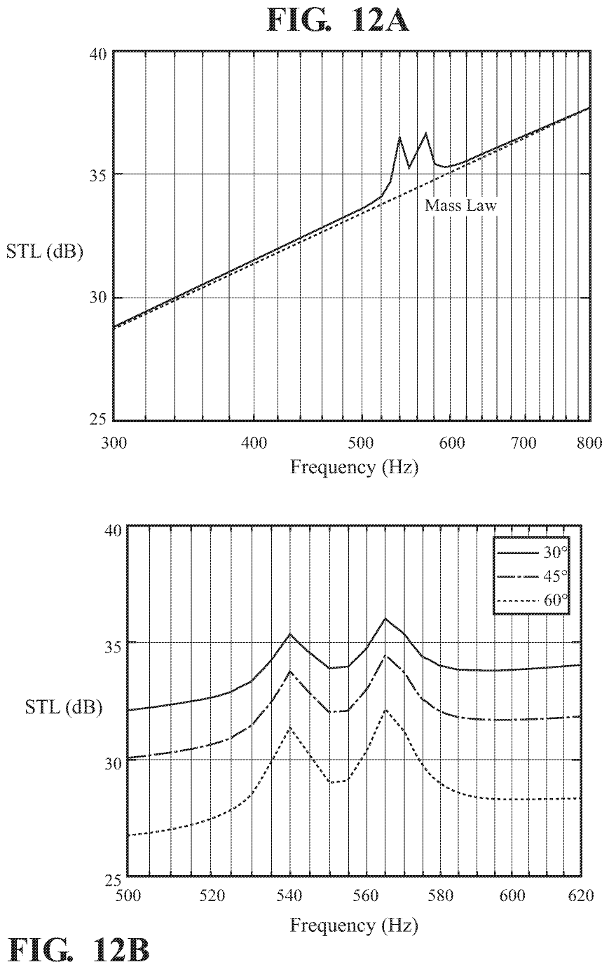

FIGS. 12A and 12B show test results if an acoustic structure 10 that utilizes different designs of resonators 12 and/or 112 having different resonant frequencies. By combining the two designs together, broadband performance can be achieved to improve STL. However, since acoustic structure 10 is covered by resonators 12 and/or 112 having different resonant frequencies, each resonator 12 and/or 112 corresponding to a specific frequency covers less area. As a result, the improvement at one specific frequency will be reduced. Nevertheless, by properly resonators 12 and/or 112 having different frequencies into an acoustic structure 10, it is possible to cover a wider range than the range shown in FIG. 12A. FIG. 12B shows broad-angle performance at fairly large incident angles such as 30°, 45°, and even 60°.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should also be understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A sound isolation structure comprising an array of resonators, at least one of the resonators forming the array of resonators comprises a housing having a cavity and an opening to the cavity and a neck portion extending into the cavity from the opening of the housing.

2. The sound isolation structure of claim 1, wherein the cavity is an air channel, the air channel having an open end connected to the opening and a terminal end terminating within the housing.

3. The sound isolation structure of claim 2, wherein the air channel is a spiral air channel.

4. The sound isolation structure of claim 3, wherein the open end is located adjacent to a center of the spiral air channel.

5. The sound isolation structure of claim 3, wherein the terminal end is located adjacent to a perimeter of the spiral air channel.

6. The sound isolation structure of claim 3, wherein the spiral air channel is a rectangular spiral air channel.

7. The sound isolation structure of claim 1, wherein the housing has a perimeter having a rectangular shape.

8. The sound isolation structure of claim 1, wherein the housing further comprises a top plate having the opening, the top plate having a side opposite of the cavity that is substantially flat.

9. The sound isolation structure of claim 1, wherein the array of resonators is a two-dimensional array of resonators.

10. A resonator for isolating sound, the resonator comprising:
a housing having an opening;
an air channel disposed within the housing, the air channel having an open end connected to an opening and a terminal end terminating within the housing; and
a neck portion extending into the air channel from the opening.

11. The resonator of claim 10, wherein the air channel is a spiral air channel.

12. The resonator of claim 11, wherein the open end is located adjacent to a center of the spiral air channel.

13. The resonator of claim 12, wherein the terminal end is located adjacent to a perimeter of the spiral air channel.

14. The resonator of claim 13, wherein the spiral air channel is a rectangular spiral air channel.

15. The resonator of claim 10, further comprising a top plate having the opening, the top plate having a side opposite of the air channel that is substantially flat.

16. A sound isolation structure comprising:
an array of resonators, at least one of the resonators forming the array of resonators comprises:
a housing having an opening,
a spiral air channel disposed within the housing, the spiral air channel having an open end connected to an opening and a terminal end terminating within the housing,
wherein the open end is located adjacent to a center of the spiral air channel and the terminal end is located adjacent to a perimeter of the spiral air channel, and
a neck portion extending into the spiral air channel from the opening.

17. The sound isolation structure of claim 16, wherein the spiral air channel is a rectangular spiral air channel.

18. The sound isolation structure of claim 16, wherein at least one of the resonators forming the array of resonators has a perimeter having a rectangular shape.

19. The sound isolation structure of claim 16, wherein the housing further comprises a top plate having the opening, the top plate having a side opposite of the spiral air channel that is substantially flat.

20. The sound isolation structure of claim 16, wherein the array of resonators is a two-dimensional array of resonators.
